(19) United States
(12) Patent Application Publication
(10) Pub. No.: US 2006/0101237 A1
(43) Pub. Date: May 11, 2006

(54) Data flow machine

(76) Inventors: Stefan Mohl, Lund (SE); Pontus Borg, Lund (SE)

Correspondence Address: HARNESS, DICKEY & PIERCE, P.L.C., P.O. BOX 8910, RESTON, VA, 20195, US

(21) Appl. No.: 11/227,997

(22) Filed: Sep. 16, 2005

Related U.S. Application Data
(63) Continuation-in-part of application No. PCT/SE04/00394, filed on Mar. 17, 2004.

(30) Foreign Application Priority Data
Mar. 17, 2003 (SE) 0300742-4

(51) Int. Cl. G06F 9/40

(52) U.S. Cl. 712/201

(57) ABSTRACT

Methods and apparatuses for automatically forming a data flow machine using a graph representing source code are provided. At least one first hardware element may be configured to perform at least one first function associated with a respective node in the graph. A firing rule for at least one of the at least one configured first hardware element may be identified. At least one second hardware element may be configured to perform at least one second function associated with a respective connection between nodes in the graph.

### PRIORITY STATEMENT

This application is a continuation-in-part under 35 U.S.C. §111(a) of PCT International Application No. PCT/SE2004/000394 which has an International filing date of Mar. 17, 2004, which designated the United States of America and which claims priority on Swedish Patent Application No. 0300742-4 filed Mar. 17, 2003, the entire contents of each of which are incorporated herein by reference.

### TECHNICAL FIELD

Example embodiments of the present invention relate to data processing methods and apparatuses. For example, methods and apparatuses for performing data processing in digital hardware at higher speeds using a data flow machine. A data flow machine, according to example embodiments of the present invention, may utilize fine grain parallelism and/or large pipeline depths.

### DESCRIPTION OF THE CONVENTIONAL ART

Many different approaches towards easier-to-use programming languages for hardware descriptions have been employed in the recent years for providing faster and/or easier ways to design digital circuitry. When programming data flow machines, a language different from the hardware descriptive language may be used. For example, an algorithm description for performing a specific task on a data flow machine may comprise the description itself, while an algorithm description, which may be executed directly in an integrated circuit, may comprise details of more specific implementations of the algorithm in hardware. For example, the hardware description may contain information regarding the placement of registers. Information regarding the placement of registers may provide optimum clock frequency for multipliers, etc.

In the conventional art data flow machines may be used as models for parallel computing, and attempts to design more efficient data flow machines have been performed. Conventional attempts to design data flow machines have produced poor results with respect to computational performance as compared to, for example, other available parallel computing techniques.

When translating program source code, conventional compilers may utilize data flow analysis and/or data flow descriptions (e.g., data flow graphs (DFGs)). These data flow graphs may improve (e.g., optimize) the performance of a compiled program. A data flow analysis performed on an algorithm may produce a data flow graph. The data flow graph may illustrate data dependencies, which may be present within the algorithm. More specifically, a data flow graph may normally comprise nodes indicating specific operations that the algorithm may perform on the data being processed. Arcs may indicate the interconnection between nodes in the graph. The data flow graph may be an abstract description of the specific algorithm and may be used for analyzing the algorithm. A data flow machine may also be a calculating machine, may execute an algorithm based on the data flow graph.

A data flow machine may operate in a different, or substantially different, way as compared to a control-flow apparatus, such as a conventional processor in a personal computer (e.g., a von Neumann architecture). In a data flow machine a program may be the data flow graph, rather than a series of operations to be performed by the processor. Data may be organized in packets known as tokens. The tokens may reside on the arcs of the data flow graph. A token may contain any data-structure to be operated on by the nodes connected by the arc, similar to, for example, a bit, a floating-point number, an array, etc. Depending on the type of data flow machine, each arc may hold either a single token (e.g., in a static data flow machine), a fixed number of tokens (e.g., in synchronous data flow machine), or an indefinite number of tokens (e.g., in a dynamic data flow machine).

Nodes in the data flow machine may wait for tokens to appear on a sufficient number of input arcs so that an operation may be performed. When the operation is performed, the tokens may be consumed and new tokens may be produced on their output arcs. For example, a node, which may perform an addition of two tokens may wait until tokens have appeared upon both inputs, consume those two tokens and produce the result (e.g., the sum of the input tokens' data) as a new token on its output arc.

Rather than, as may be done in a CPU, selecting different operations to operate on the data depending on conditional branches, a data flow machine may direct the data to different nodes depending on conditional branches. Thus, a data flow machine may have nodes, which may produce (e.g., selectively produce) tokens on specific outputs (e.g., referred to as a switch-node) and also nodes that may consume (e.g., selectively consume) tokens on specific inputs (e.g., referred to as a merge-node). Another example of a common data flow manipulating node is a gate-node. A gate-node may remove (e.g., selectively remove) tokens from the data flow. Many other data flow manipulating nodes may also be possible.

Each node in the graph may perform its operation, for example, independently from any or all other nodes in the graph. After a node has data on its relevant input arcs, and there is space to produce a result on its relevant output arcs, the node may execute its operation (e.g., referred to as firing). The node may fire regardless of the ability of other nodes to fire. There may be no specific order in which the nodes' operations may execute. In a control-flow apparatus, for example, the order of executions of the operations in the data flow graph may be irrelevant. In one example, the order of execution may be simultaneous execution of all nodes able to fire.

As mentioned above, data flow machines may be, depending on their designs, divided into, for example, three categories: static data flow machines, dynamic data flow machines, and synchronous data flow machines.

In a static data flow machine, every arc in the corresponding data flow graph may hold a single token at each time instant.

In a dynamic data flow machine each arc may hold an indefinite number of tokens while waiting for the receiving node to be prepared to accept them. This may allow construction of recursive procedures with recursive depths that may be unknown when designing the data flow machine. Such procedures may reverse data being processed in the recursion. This may result in incorrect matching of tokens when performing calculations after the recursion is finished.

The situation above may be handled, for example, by adding markers, which may indicate a serial number of every token in the protocol. The serial numbers of the tokens inside the recursion may be monitored (e.g., continuously monitored). When a token exits the recursion it may not be allowed to proceed as long as it may not be matched to tokens outside the recursion.

If the recursion is not a tail recursion, context may be stored in the buffer at each recursive call in the same way as context may be stored on the stack when recursion is performed using a conventional processor. A dynamic data flow machine may execute data-dependent recursions in parallel.

Synchronous data flow machines may operate without the ability to let tokens wait on an arc while the receiving node prepares itself. Instead, the relationship between production and consumption of tokens for each node may be calculated in advance. This advance calculation may allow for determining how to place the nodes and/or assign sizes to the arcs with regard to the number of tokens, which may reside on them, for example, simultaneously. This may improve the likelihood that each node produces as many tokens as a subsequent node consumes. The system may then be designed such that each node may produce data (e.g., constantly) since a subsequent node may consume the data (e.g., constantly). However, a drawback may be that no indefinite delays, such as, data-dependent recursion may exist in the construction.

Conventionally, data flow machines may be used in conjunction with computer programs run in traditional CPUs. For example, a cluster of computers may be or an array of CPUs on a board (e.g., a printed circuit board). Dataflow machines may enable the exploit their parallelism and construct experimental super-computers. Attempts have been made to construct dataflow machines directly in hardware; for example, by creating a number of processors in an Application Specific Integrated Circuit (ASIC). This approach in contrast to using processors on a circuit board may provide higher communication rates between processors on the same ASIC.

Field Programmable Gate Arrays (FPGA) and other Programmable Logic Devices (PLD) may also be used for hardware construction. FPGAs are silicon chips that may be re-configurable on the fly. FPGAs may be based on an array of small random access memories (RAMs), for example, Static Random Access Memory (SRAM). Each SRAM may hold a look-up table for a boolean function. This may enable the FPGA to perform any logical operation. The FPGA may also hold configurable routing resources. This may allow signals to travel from SRAM to SRAM.

By assigning the logical operations of a silicon chip to the SRAMs and configuring the routing resources, any hardware construction small enough to fit on the FPGA surface may be implemented. An FPGA may implement fewer, or substantially fewer, logical operations on the same amount of silicon surface compared to an ASIC. An FPGA may be changed to any other hardware construction, for example, by entering new values into the SRAM look-up tables and changing the routing. An FPGA may be seen as an empty silicon surface that may accept any hardware construction, and that may change to any other hardware construction at shorter notice (e.g., less than 100 milliseconds).

Other common PLDs may be fuse-linked and permanently configured. A fuse-linked PLD may be constructed more easily. To manufacture an ASIC, a more expensive and/or complicated process may be required. In contrast, a PLD may be constructed in a few minutes using a simpler tool. Various techniques for PLDs may overcome at least some of the drawbacks of fuse-linked PLDs and/or FPGAs.

Conventionally, in order to program the FPGA, the place-and-route tools provided by the vendor of the FPGA may be used. The place-and-route software may accept either a netlist from a synthesis software or the source code from a Hardware Description Language (HDL) that it may synthesize directly. The place-and-route software may output digital control parameters in a description file used for programming the FPGA in a programming unit. Similar techniques may be used for other PLDs.

When designing integrated circuits, the circuitry may be designed as state machines since they provide a framework that may simplify construction of the hardware. State machines may be useful when implementing complicated flows of data, where data will flow through logic operations in various patterns depending on prior calculations.

State machines may also allow re-use of hardware elements. This may improve and/or optimize the physical size of the circuit. This may allow integrated circuits to be manufactured at lower cost.

Previous constructions of data flow machines using specialized hardware have been based on connecting state machines or specialized CPUs (which is a special case of a state machine) to each other. These may be connected with specialized routing logic and/or specialized memories. For example, in designs of data flow machines, state machines have been used for emulating the behaviour of the data flow machine. Moreover, earlier data flow machines have been in the form of dynamic data flow machines, so token matching and re-ordering components may be used.

In one example, a data flow machine may be emulated by a multi-processing system according to the above. In the multi-processing system up to 512 processing elements (PE) may be arranged in a three-dimensional structure. Each PE may constitute a complete VLSI-implemented computer with a local memory for program and data storage. Data may be transferred between the different PEs in form of data packets, which may contain both data to be processed as well as an address identifying the destination PE and an address identifying an actor within the PE. Moreover, the communication network interconnecting the PEs may be designed with automatic retry on garbled messages, distributed bus arbitration, alternate-path packet routing, etc. The modular nature of the computer may allow additional processing elements to be added in order to meet a range of throughput and reliability requirements.

In this example, the structure of the emulated data flow machine may be increasingly complex and may not fully utilize the data flow structure presented in the data flow graph. The monitoring of packets being transferred back and forth in the machine may imply the addition of unnecessary logic circuitry.

In another conventional example, a data flow machine may include a set of processors arranged for obtaining a homogeneous flow of data. The data flow machine may be included in an apparatus called (Alfa). This machine, however, may not be optimized with regard to the structure of earlier established data flow graphs, for example, many steps may be performed after establishing the data flow graph. This may make the machine suitable for implementation by use of hardware units in form of computers. In this example, the machine may facilitate a homogenous flow of data through a set of identical hardware units (computers), but may not implement the data flow graph in hardware in a computational efficient manner.

A super-computer built with larger numbers of processors in the form of a data flow machine, was hoped to achieve a higher degree of parallelism. For example, super-computers have been built with processors such as CPUs or ASICs, each including many state machines. Since designs of earlier data flow machines have included the use of state machines (e.g., in the form of processors) in ASICs, a more straightforward method to implement data flow machines in programmable logical devices like FPGA may be to use state machines. A general feature for previously known data flow machines is that the nodes of an established data flow graph do not correspond to specific hardware units (e.g., known as functional units, FU) in the final hardware implementation. Instead, hardware units, which may be available at a specific time instant, may be used for performing calculations specified by the nodes affected in the data flow graph. If a node in the data flow graph is to be performed more than once, different functional units may be used each time the node is performed.

Previous data flow machines have been implemented by the use of state machines or processors to perform the function of the data flow machine. Each state machine may be capable of performing the function of any node in the data flow graph. This may be needed to enable each node to be performed in any functional unit. Since each state machine may be capable of performing any node's function, the hardware required for any other node apart from the currently executing node will be dormant. State machines (e.g., with supporting hardware for token manipulation) may be the realization of the data flow machine itself. It may not be the case that the data flow machine is implemented by other means, and may contain state machines in its functional nodes.

Most programming languages used today are so-called imperative languages, for example, languages such as Java, Fortran, and Basic. These languages are almost impossible, or at least very hard, to re-write as data flows without loosing parallelism.

Instead, the use of functional languages rather than imperative languages simplifies the design of data flow machines. Functional languages are characterized in that they exhibit a feature called referential transparency. That is, for example, the meaning or value of immediate component expressions is significant in determining the meaning of a larger compound expression. Since expressions are equal if and only if they have the same meaning, referential transparency means that equal sub-expressions may be interchanged in the context of a larger expression to give equal results.

If execution of an operation has effects besides providing output data (e.g., a read-out on a display during execution of the operation) it may not be referentially transparent since the result from executing the operation is not the same as the result without execution of the operation. All communication to or from a program written in a referentially transparent language is called side-effects (e.g., memory accesses, read-outs, etc).

In another example, a high-level software-based description of an algorithm may be compiled into digital hardware implementations. The semantics of the programming language may be interpreted through the use of a compilation tool that analyzes the software description to generate a control and data flow graph. This graph may then be the intermediate format used for improvements, optimizations, transformations and/or annotations. The resulting graph may then be translated to either a register transfer level or a netlist-level description of the hardware implementation. A separate control path may be utilized for determining when a node in the flow graph shall transfer data to an adjacent node. Parallel processing may be achieved by splitting the control path and the data path. By using the control path, wavefront processing may be achieved. For example, data may flow through the actual hardware implementation as a wavefront controlled by the control path.

The use of a control path may imply that parts of the hardware may be used while performing data processing. The rest of the circuitry may wait for the first wavefront to pass through the flow graph, so that the control path may launch a new wavefront.

In yet another conventional example, pre-designed and verified data-driven hardware cores may be assembled to generate large systems on a single chip. Tokens may be synchronously transferred between cores over dedicated connections using a one-bit ready signal and a one-bit request signal. The ready-request signal handshake may be sufficient for token transfer. Also, each of the connected cores may be of at least finite state machine complexity. There may be no concept of a general firing mechanism, so no conditional re-direction of the flow of data may be performed. Thus, no data flow machine may be built with this system. Rather, the protocol for exchange of data between cores focuses on keeping pipelines within the cores full.

In another example, an architecture for general purpose computing may combine reconfigurable hardware and compiler technology to produce application-specific hardware. Each static program instruction may be represented by a dedicated hardware implementation. The program may be decomposed into smaller fragments called split-phase abstract machines (SAM) which may be synthesized in hardware as state machines and combined using an interconnecting network. During execution of the program, the SAMs may be in one of three states: inactive, active or passive. Tokens may be passed between different SAMs, and may enable the SAMs to start execution. This implies that a few SAMs at a time may perform actual data processing, the rest of the SAMs may be waiting for the token to enable execution. Power consumption may be reduced in this example; however, computational capacity may also be reduced.

### SUMMARY OF THE INVENTION

Example embodiments of the present invention provide methods and apparatuses, which may improve the performance of a data processing system.

Example embodiments of the present invention may increase the computational capability of a system, for example, by implementing a data flow machine in hardware, wherein higher parallelism may be obtained. Example embodiments of the present invention may improve the utilization the available hardware resources, for example, a larger portion of the available logic circuitry (e.g., gates, switches etc) may be used simultaneously.

An example embodiment of the present invention provides a method for generating descriptions of digital logic from high-level source code specifications, wherein at least part of the source code specification may be compiled into a multiple directed graph representation comprising functional nodes with at least one input or one output, and connections indicating the interconnections between the functional nodes. Moreover, hardware elements may be defined for each functional node of the graph, wherein the hardware elements may represent the functions defined by the functional nodes. Additional hardware elements may be defined for each connection between the functional nodes, wherein the additional hardware elements may represent transfer of data from a first functional node to a second functional node. A firing rule for each of the functional nodes of the graph may be defined. The firing rule may define a condition for the functional node to provide data at its output and to consume data at its input.

Another example embodiment of the present invention provides a method for generating digital control parameters for implementing digital logic circuitry from a graph representation comprising functional nodes. The functional nodes may comprise at least one input or at least one output, and/or connections indicating the interconnections between the functional nodes. The method may comprise configuring a merged hardware element to perform functions associated with at least a first and a second functional node, and configuring a firing rule for the hardware element resulting from the merge of the first and second functional node.

Another example embodiment of the present invention provides an apparatus for generating digital control parameters for implementing digital logic circuitry from a graph representation. The apparatus may include functional nodes. The functional nodes may include at least one input, at least one output, and/or connections indicating the interconnections between the functional nodes. The apparatus may be adapted to configure a merged hardware element to perform functions associated with at least a first and a second functional node, and/or configure a firing rule for the hardware element resulting from the merge of the first and second functional node.

Another example embodiment of the present invention provides a method of enabling activation of a first and second interconnected hardware element in a data flow machine. The method may include receiving, at a first hardware element, a first digital data element, the reception of the first digital data element enabling activation of the first hardware element, transferring the first digital data element from the first hardware element to the second hardware element, the reception of the first digital data element at the second hardware element enabling activation of the second hardware element, and the transferring of the first digital data element from the first hardware element deactivating the first hardware element.

Another example embodiment of the present invention provides a data flow machine. The data flow machine may include a first hardware element interconnected with a second hardware element and receiving a first digital data element enabling activation when the first digital data element is present in the first hardware element. The first hardware element may be adapted to transfer the first digital data element from the first hardware element to the second hardware element. The second hardware element may be adapted to receive the first digital data element enabling activation of the second hardware element. The transferring of the first digital data from the first hardware element disables activation of the first hardware element.

Another example embodiment of the present invention provides a method of ensuring data integrity in a data flow machine having at least one stall line connected to at least a first and a second hardware elements arranged to provide a data path in the data flow machine, the stall line suspending flow of data progressing in the data path from the first hardware element to the second hardware element during a processing cycle, for example, when a stall signal is active on the stall line. The method may include receiving the stall signal from the second hardware element at a first input of a on-chip memory element, receiving data from the first hardware element at a first input of a second on-chip memory element, buffering the received data and the received stall signal in the first and second on-chip memory element, respectively, for at least one processing cycle, receiving the buffered stall signal at the first hardware element from a first output of the first on-chip memory element, and receiving the buffered data at the second hardware element from a first output of the second on-chip memory element.

Another example embodiment of the present invention provides a method of generating digital control parameters for implementing digital logic circuitry from a graph representation. The graph representation may include functional nodes with at least one input, at least one output, and/or connections indicating the interconnections between the functional nodes. The method may include defining digital control parameters identifying at least a first set of hardware elements for the functional nodes, the connections between the functional node, and/or defining digital control parameters identifying at least one re-ordering hardware element ordering data elements emitted from at least one first set of hardware elements so that data elements may be emitted from the first set of hardware elements in the same order as they enter the first set of hardware elements.

Another example embodiment of the present invention provides an apparatus for ensuring data integrity in a data flow machine, wherein at least one stall line may be connected to at least a first and a second hardware elements arranged to provide a data path in the data flow machine. The stall line may suspend flow of data progressing in the data path from the first hardware element to the second hardware element during a processing cycle, for example, when a stall signal is active on the stall line. The apparatus may be adapted to receive the stall signal from the second hardware element at a first input of a first on-chip memory element, receive data from the first hardware element at a first input of a second on-chip memory element, buffer the received data and the received stall signal in the first and second on-chip memory element, respectively, for at least one processing cycle, receive the buffered stall signal at the first hardware element from a first output of the first on-chip memory element, and receive the buffered data at the second hardware element from a first output of the second on-chip memory element.

Another example embodiment of the present invention provides an apparatus for generating digital control parameters for implementing digital logic circuitry from a graph representation. The graph representation may include functional nodes with at least one input, at least one output, and/or connections indicating the interconnections between the functional nodes. The apparatus may be adapted to define digital control parameters identifying at least a first set of hardware elements for the functional nodes and/or the connections between the functional node, and define digital control parameters identifying at least one re-ordering hardware element ordering data elements emitted from at least one first set of hardware elements so that data elements may be emitted from the first set of hardware elements in the same order as they enter the first set of hardware elements.

Another example embodiment of the present invention provides a data flow machine. The data flow machine may include a first set of hardware elements performing data transformation, and at least one re-ordering hardware element. The at least one reordering hardware element may order data elements emitted from at least one first set of hardware elements so that data elements may be emitted from the first set of hardware elements in the same order as they enter the first set of hardware elements.

Another example embodiment of the present invention provides a method for automatically forming a data flow machine using a graph representing source code. At least one first hardware element may be configured to perform at least one first function associated with a respective node in the graph. A firing rule for at least one of the at least one configured first hardware element may be identified. At least one second hardware element may be configured to perform at least one second function associated with a respective connection between nodes in the graph.

Another example embodiment of the present invention provides an apparatus for automatically forming a data flow machine using a graph representing source code. The apparatus may configure at least one first hardware element to perform at least one first function associated with a respective node in the graph, identify a firing rule for at least one of the at least one configured first hardware element, and/or configure at least one second hardware element to perform at least one second function associated with a respective connection between nodes in the graph.

Another example embodiment of the present invention provides an apparatus embodying a data flow machine. The apparatus may include at least one first hardware element and at least one second hardware element. The at least one first hardware element may perform at least one first function associated with a respective node in the graph. The at least one first function may be performed based on at least one firing rule. The at least one second hardware element may perform at least one second function associated with a respective connection between nodes in the graph.

Another example embodiment of the present invention provides a method of enabling activation of at least a first and a second hardware element in a data flow machine. A first digital data element may be provided and may activate the first hardware. The first digital data element may be transferred from the first hardware element to the second hardware element, may activate the second hardware element, and may de-activate the first hardware element.

Another example embodiment of the present invention provides a method of ensuring data integrity in a data flow machine. A stall signal may be received from a second hardware element at a first input of a first memory element. Data may be received from a first hardware element at a first input of a second memory element. The received data and the received stall signal may be buffered in the first and second memory elements, respectively, for at least one processing cycle. The buffered stall signal may be received at the first hardware element from a first output of the first memory element, and the buffered data may be received at the second hardware element from a first output of the second memory element.

Another example embodiment of the present invention provides an apparatus adapted to receive the stall signal from the second hardware element at a first input of a first memory element, receive data from the first hardware element at a first input of a second memory element, buffer the received data and the received stall signal in the first and second memory elements, respectively, for at least one processing cycle, receive the buffered stall signal at the first hardware element from a first output of the first memory element, and receive the buffered data at the second hardware element from a first output of the second memory element.

Another example embodiment of the present invention provides a method in which at least a first set of hardware elements may be identified as at least one functional node or connection between functional nodes. Data elements emitted from at least one first hardware element may be ordered so that data elements are emitted from the at least one first hardware element in the same order as they enter the first set of hardware elements by identifying at least one hardware element.

Another example embodiment of the present invention provides an apparatus adapted to identify at least a first set of hardware elements as at least one functional node or connection between functional nodes. The apparatus may also identify at least one hardware element ordering data elements emitted from at least one first hardware element so that data elements are emitted from the at least one first hardware element in the same order as they enter the first set of hardware elements.

In example embodiments of the present invention, the graph representation may be a directed graph.

In example embodiments of the present invention, at least one output of the first functional node and/or at least one input of the second functional node may be connected, for example, directly connected.

In example embodiments of the present invention, a firing rule may be configured for the merged hardware element, which may be different from the firing rules of the first and second functional nodes.

In example embodiments of the present invention, the graph representation may be generated from high-level source code specifications.

In example embodiments of the present invention, the apparatus may be further adapted to configure a firing rule in the merged hardware element, which may different from the firing rules of the first and second functional nodes.

Example embodiments of the present invention may be embodied in a computer program product loadable into the memory of an electronic device having digital computer capabilities. The computer program product embodied on a computer-readable medium.

Example embodiments of the present invention may further include receiving, at the first hardware element, a second digital data element after transferring the first digital data element.

In example embodiments of the present invention, the digital data element may be generated in the first hardware element.

In example embodiments of the present invention, the digital data element may be generated in a separate hardware element and transferred to the first hardware element.

In example embodiments of the present invention, the digital data element may be transferred from the second hardware element and returned to the first hardware element.

In example embodiments of the present invention, the first hardware element may receive a second digital data element, for example, after transferring the first digital data element to the second hardware element.

In example embodiments of the present invention, the digital data element may be transferred from the second hardware element and returned to the first hardware element.

In example embodiments of the present invention, data flow machine may be an ASIC, FPGA, CPLD, any other suitable PLD, etc.

In example embodiments of the present invention, at least one on-chip memory element may be a register.

Example embodiments of the present invention may further include defining digital control parameters identifying on-chip memory elements accessible (e.g., independently accessible) in parallel for at least one connection between the functional nodes.

Example embodiments of the present invention may further include defining digital control parameters identifying digital registers for at least one connection between the functional nodes.

Example embodiments of the present invention may further include defining digital control parameters identifying at least one flip/flop for at least one connection between the functional nodes.

Example embodiments of the present invention may further include defining digital control parameters identifying at least one latch for at least one connection between the functional nodes.

Example embodiments of the present invention may also overcome limitations in computational efficiency, which may be present in conventional data flow machines due to, for example, the use of a dedicated control path for enabling flow of data between different functional units. Example embodiments of the present invention may enable increased computational capacity compared to conventional solutions as a consequence of efficient data storage in the data flow machine without the need for intense communication with an external memory.

Example embodiments of the present invention may implement the function described by a data flow graph in hardware in a more efficient way without the need for specialized interconnected CPUs or advanced data exchange protocols. Example embodiments of the present invention make more use of the similarities in semantics between data flow machines and RTL (Register Transfer Level) logic in that combinatorial logic may be used instead of CPUs, and hardware registers may be used instead of RAMs (Random Access Memory), backplanes, and/or Ethernet networks.

Example embodiments of the present invention may enable design of silicon hardware from high level programming language descriptions. A high level programming language is a programming language that focuses on the description of algorithms in themselves, rather than on implementation of an algorithm in a specific type of hardware. With a high level programming language and the capability to automatically design integrated circuit descriptions from programs written in the language, it may be possible to use software engineering techniques for the design of integrated circuits. This may be advantageous for FPGAs and other re-configurable PLDs that may be re-configured with many different hardware designs at little or no cost.

Apart from benefiting from many different, easily created hardware designs, FPGAs and other PLDs may have an efficiency benefit from example embodiments of the present invention. If systems, according to example embodiments of the present invention, may exploit a larger amount of parallelism it may be capable of filling as large a part of the PLD as possible with meaningful operations, providing higher performance. This is in contrast to traditional hardware design which usually focuses on creating as small designs as possible.

Other aspects of example embodiments of the present invention will appear more clearly from the following detailed disclosure of example embodiments.

### BRIEF DESCRIPTION OF THE DRAWINGS

An example embodiment of the present invention will now be described with reference to the accompanying drawings, in which:

FIG. 1a is a schematic view illustrating a first data flow graph known per se;

FIG 1b is a schematic view illustrating a second data flow graph known per se;

FIG. 2 illustrates an example embodiment of the present invention;

FIG. 3 illustrates another example embodiment of the present invention wherein the lengths of different data paths have been equalized;

FIG. 4a is a detailed schematic view of a node according to another example embodiment of the present invention;

FIG. 4b illustrates an example of the logic circuitry for establishing a firing rule according to an example embodiment of the present invention;

FIG. 4c correspondingly illustrates an example of the logic circuitry used in the registers between the nodes in the data flow machine according to an example embodiment of the present invention;

FIG. 5a illustrates another example embodiment of the present invention wherein the lengths of different data paths have been equalized by means of node merging;

FIG. 5b is a more detailed illustration of the merging of two nodes in FIG. 5a according to an example embodiment of the present invention; and

FIG. 6 illustrates a stall cutter according to an example embodiment the present invention.

### DETAILED DESCRIPTION OF EXAMPLE EMBODIMENTS OF THE PRESENT INVENTION

The transformation of a source-code program into a data flow graph may be done by data flow analysis. A more simple method for performing data flow analysis may be as follows. Start at all the outputs of the program. Find the immediate source of each output. If it is an operation, replace the operation with a node and join it to the output with an arc. If the source is a variable, replace the variable with an arc and connect it to the output. Repeat for all arcs and nodes that lack fully specified inputs.

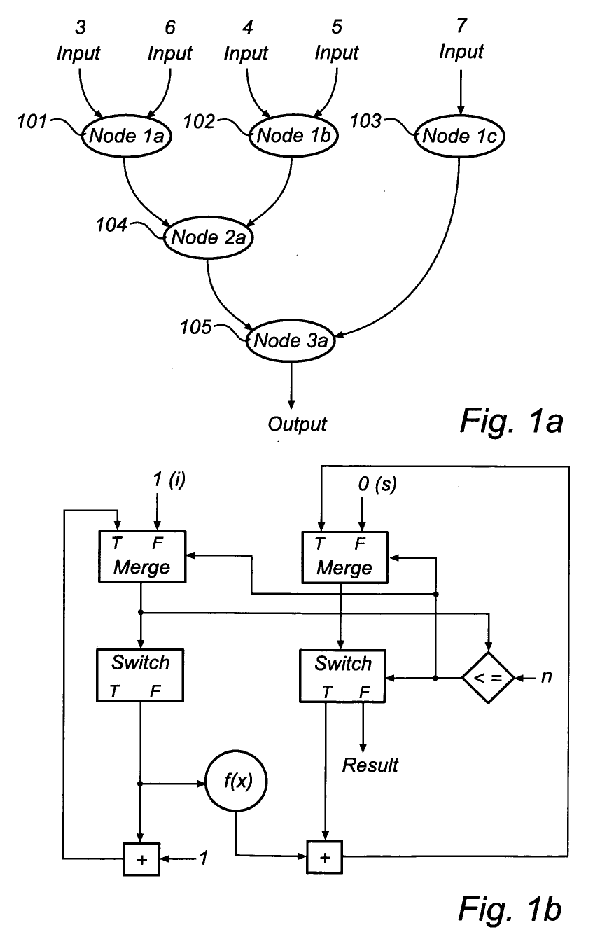

FIG. 1a illustrates a conventional data flow graph. For the sake of brevity, throughout this text the term node will be used to indicate a functional node in the. data flow graph. Three processing levels are shown in FIG. 1a: the top nodes 101, 102, 103 may receive input data from one or more sources at their inputs, which data may be processed as it flows through the graph. The actual mathematical, logical and/or procedural function performed by the top nodes may be specific for each implementation, as it depends on the source code, from which the data flow graph may originate. For example, the first node 101 may perform addition of data from the two inputs, the second node 102 may perform a subtraction of data received at the first input from data received at the second input, and the third node 103 may e.g. perform a fixed multiplication by two of data received at its input. The number of inputs for each node, the actual processing performed in each node, etc may be different for different implementations and may not be limited by the examples above. A node may, for example, perform more complex calculations or access external memories, which will be described below.

Data is flowing from the first node level to the second node level, where in this case data from nodes 101 and 102 may be transferred from the outputs of nodes 101 and 102 to the inputs of node 104. In accordance with the discussion above, node 104 may perform a more specific task based on the information received at its inputs.

After processing in the second level, data may be transferred from the output of node 104 to a first input of node 105, which node may be located in the third level. As can be seen from FIG. 1, data from the output of node 103 in level 1 may be received at a second input of node 105. The fact that no second-level node is present between node 103 and 105 may imply that data from node 103 may be available at the second input of node 105 before data is available at the first input node of node 105 (e.g., assuming equal, or substantially equal, combinatorial delay at each node). Each node may be provided with a firing rule, which may define a condition for the node to provide data at its output. This may allow this situation to be handled more efficiently.

For example, firing rules may be mechanisms that control the flow of data in the data flow graph. By the use of firing rules, data may be transferred from the inputs to the outputs of a node while the data may be transformed according to the function of the node. Consumption of data from an input of a node may occur if there are data available at that input. Correspondingly, data may be produced at an output if there are no data from a previous calculation blocking the path (e.g., a subsequent node has consumed the previous data item). At some instances it may be possible to produce data at an output irrespective of the old data block the path; the old data at the output may then be replaced with the new data.

A specification for a general firing rule may comprise:
1) the conditions for each input of the node in order for the node to consume the input data,
2) the conditions for each output of the node in order for the node to produce data at the output, and
3) the conditions for executing the function of the node.

The conditions may depend on the values of input data, existence of valid data at inputs or outputs, the result of the function applied to the inputs or the state of the function, but may depend on any data available to the system.

By establishing general firing rules for the nodes 101-105 of the system, it may be possible to control various types of programs without the need of a dedicated control path. However, using firing rules it may be possible, in some cases, to implement a control flow. In another example without firing rules, all nodes 101-105 operate when data are available at all the inputs of the nodes 101-105.

An example of the functioning of firing rules may be given through the merge node. By this node it may be possible to control the flow of data without the need of a control flow. The merge node may have two data inputs from one of which data will be selected. It may also have a control input, which may be used for selecting which data input to fetch data from. It may also have one data output at which the selected input data value may be delivered.

For example, assume that the node has two inputs, T and F. The condition controlling the node may be received on an input C and the result may be provided at the output R. The firing rule below may produce data at the output of the node, for example, even if there are only data available at one input. In this example, if, for example, C=1, no data need be present at the input F. The condition for consuming data at the inputs of the node is:

(C=1 AND T=x) OR (C=0 AND F=x)

where x signifies existence of a valid value.

In addition, the condition for providing data at the output of the node is:

(C=1 AND T=x) OR (C=0 AND F=x)

and the function of the node is:

R=IF (C==1) T ELSE F

Another type of node for controlling the data flow is the switch. The switch node may have two outputs, T and F, one data input D, and one control input C. The node may provide data at one of its outputs when data may be available at the data input and the control input. The condition for consuming data from the inputs is:

C=x AND D=x

and the condition for providing data at the outputs is:

T: C=1 AND D=x

F: C=0 AND D=x

and the function of the node is:

T=IF (C==1) D

F=IF (C==0) D

FIG. 1b illustrates the use of the merge and switch nodes for controlling the flow of data in a data flow machine. In this example, the data flow machine may calculate the value of s according to a function:

$$s = {\sum }_{i = 1}^{n} f ( {x}_{i} )$$

Following the reasoning above, it may be possible to establish firing rules for all kinds of possible nodes,for example, True-gates (e.g., one data input D, one control input C, one output R, and function R=IF (C==1) D); Non-deterministic priority-merge (e.g., two data inputs D1 and D2, one output R, and function R=IF (D1) D1 ELSE IF (D2) D2); Addition (e.g., two data inputs D1 and D2, one output R, and function R=D1+D2); Dup (e.g., one data input D, one control input C, one output R and function R=D); and Boolstream (e.g., no inputs, one output R, and function:

R=IF (state==n) set state=0, return 1
ELSE increment state, return 0

However, independently of the function of the node, after processing the data at its inputs, node 105 may provide a value of the data processing at its output. In this example data at the five inputs have produced data at a single output.

When examining the semantics of a data flow machine closely, the observation that semantics may be very similar to the way digital circuitry operates, for example, at the register transfer level (RTL). In a data flow machine, data may reside on arcs and may be passed from one arc to another using a functional node that performs some operation on the data. In digital circuitry, data may reside in registers and may be passed between registers using, for example, combinatorial logic that performs some function on the data. Since a similarity exists between the semantics of the data flow machine and the operation of digital circuitry, it may be possible to implement the data flow machine directly in the digital circuitry. For example, the propagation of data through data flow machines may be implemented in digital circuitry without the need for simulation devices like state machines to perform the actions of the data flow machine. Instead, the data flow machine may be implemented directly by replacing nodes with combinatorial logic and arcs with registers or other fast memory elements that may be accessed (e.g., independently) in parallel.

This may improve execution speed. Such an implementation may enable a higher level of parallelism than an implementation through processors or other state machines. It may be easier to pipeline, and the level of parallelism may have finer granularity. Avoiding the use of state-machines for implementing the data flow machine itself may still permit the nodes of the data flow machine to contain state-machines.

An alternative description of example embodiments of the present invention may include special register-nodes inserted between the functional nodes of the data flow graph. In this example embodiment edges may be implemented as wires. For the sake of brevity, we describe this example embodiment in terms of nodes as combinatory logic and edges as registers, rather than using functional nodes, register nodes and edges.

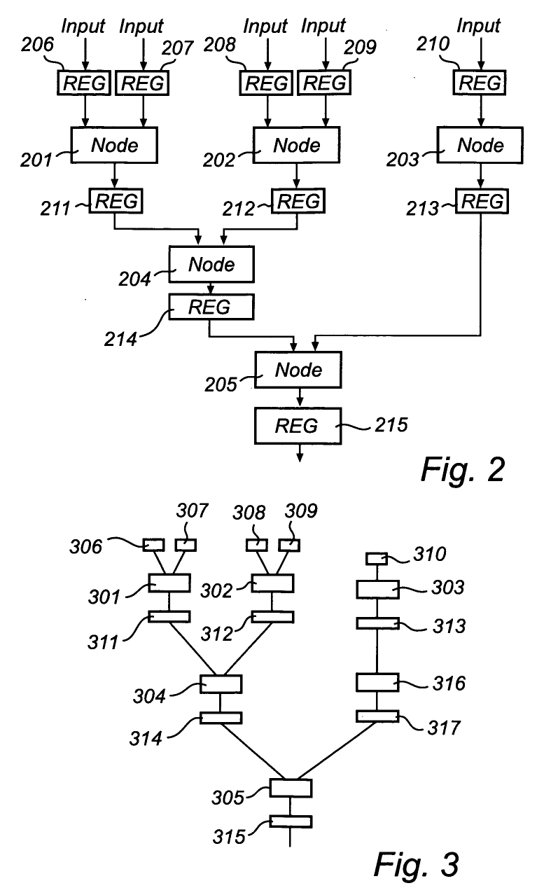

FIG. 2 illustrates an example embodiment of the present invention. FIG. 2 illustrates a hardware implementation of the data flow graph of FIG. 1. The functional nodes 101-105 of FIG. 1 have been replaced by nodes 201-205 which may perform the mathematical or logical functions defined in the data flow graph of FIG. 1. This function may be performed by combinatorial logic, and/or, for example, by a state machine and/or some pipelined device.

In FIG. 2, wires and fast parallel data-storing hardware, such as registers 206-215 or flip-flops have replaced the connections between the different nodes of FIG. 1. Data provided at the output of a node 201-205 may be stored in a register 206-215 for immediate or subsequent transfer to another node 201-205. As is understood from FIG. 2, register 213 may enable storing of the output value from node 203 while data from nodes 201 and 202 are processed in node 204. If no registers 206-215 were available between the different nodes 201-205, data at the inputs of some nodes may be unstable (e.g., change value) due to different combinatorial delays in previous nodes in the same path.

For example, assume that a first set of data has been provided at the inputs of nodes 201-203 (e.g., via registers 206-210). After processing in the nodes, data will be available at the outputs of the nodes 201-203. Nodes 201 and 202 may provide data to node 204 while node 203 may provide data to node 205. Since node 205 may also receive data from node 204, data may be processed in node 204, for example, before being transferred to node 205. If new data is provided at the inputs of nodes 201-203 before data has propagated through node 204, the output of node 203 may have changed. Hence, data at the input of node 205 may no longer be correct, for example, data provided by node 204 may be from an earlier instant compared to data provided by node 205.

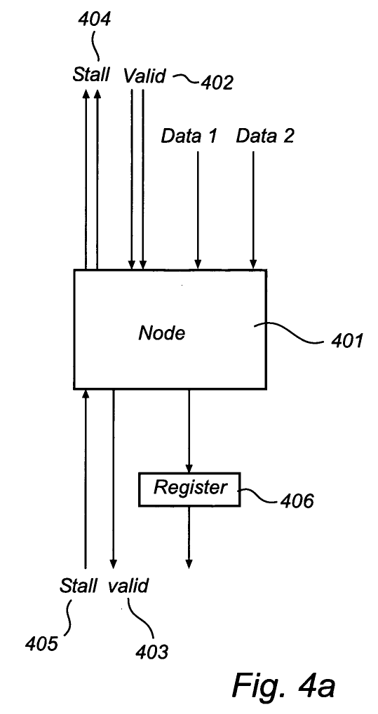

In practice, advanced clocking schemes, communication protocols, additional nodes/registers, or additional logic circuits may be needed in order to help guarantee that data provided to the different nodes are correct. A more straightforward solution to the problem is shown in FIG. 3, where an additional node 316 and its associated register 317 have been inserted into the data path. The node 316 may perform a NOP (No Operation) and may, consequently, not alter the data provided at its input. By inserting the node 316, the same length may be obtained in each data path of the graph. This may allow the arc between 203 and 205 to hold two elements.

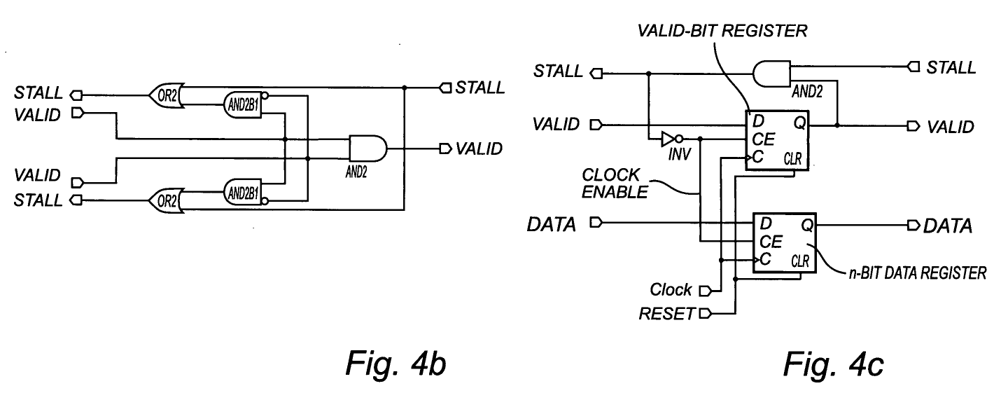

Another approach is illustrated in FIG. 4a, where each node 401 is provided with additional signal lines for providing correct data at every time instant. The first additional lines carry “valid” signals 402, which may indicate that previous nodes have stable data at their outputs. Similarly, the node 401 may provide a “valid” signal 403 to a subsequent node in the data path when the data at the output of node 401 is stable. By this procedure, each node may be able to determine the status of the data at its inputs.

Moreover, second additional lines carry a “stall” signal 404, which may indicate to a previous node that the current node 401 is not prepared to receive any additional data at its inputs. Similarly, the node 401 may also receive a “stall” line 405 from a subsequent node in the data path. By the use of stall lines it may be possible to temporarily stop the flow of data in a specific path. This may be increasingly important in cases in which a node at some time instances performs time-consuming data processing with indeterminate delay, such as loops or memory accesses. The use of a stall signal is a one example embodiment of the present invention. However, several other signals may be used, depending on the protocol chosen. Examples include “data consumed”, “ready-to-receive”, “acknowledge” or “not-acknowledge”-signals, and signals based on pulses or transitions rather than a high or low signal. Other signaling schemes are also possible. The use of a “valid” signal may enable representation of the existence or non-existence of data on an arc. Thus, not only synchronous data flow machines may be constructed, but also static and dynamic data flow machines. The “valid” signal may not have to be implemented as a dedicated signal-line, it may be implemented in several other ways, such as, choosing a special data value to represent a “null”-value. As for the stall signal, there are many other possible signaling schemes. For brevity, the rest of this document will only refer to stall and valid signals. It is more simple to extend the function of example embodiments of the present invention to other signaling schemes.

With the existence of a specific stall signal, it may be possible to achieve higher efficiency. The stall signal may enable a node to know that even if the arc below is full at the moment, it may be able to accept an output token at the next clock cycle. Without a stall signal, the node may have to wait until there is no valid data on the arc below before it can fire. That is, for example, an arc will be empty at least every other cycle. This may decrease efficiency.

FIG. 4b illustrates an example of the logic circuitry for producing the valid 402, 403 and stall 404, 405 signals for a node 401 according to an example embodiment of the present invention. The circuitry shown in FIG. 4 may be used in nodes which may fire when data is available on all inputs. For example, the firing rule may be more complex and may be established in accordance with the function of the individual node 401.

FIG. 4c illustrates an example of the logic circuitry used in the registers 406 between the nodes in the data flow machine according to an example embodiment of the present invention. This circuitry may ensure that the register will retain its data if the destination node is not prepared to accept the data; and signal this to the source node. It may also accept new data if the register is empty, or if the destination node is about to accept the current contents of the register. In FIG. 4c, one data input 407 and one data output 408 are illustrated for reasons of brevity. However, it is emphasized that the actual number of inputs and outputs may depend on bus width of the system (e.g., how many bits wide the token is).

In a complex data flow machine, the stall lines may become longer compared to the signal propagation speed. This may result in that the stall signals not reaching every node in the path that needs to be stalled. This may result in loss of data (e.g., data which has not yet been processed may be written over by new data).

Two common methods for solving this situation are balancing the stall signal propagation path to ensure that it reaches all target registers in time or a fifo-buffer is placed after the stoppable block, avoiding the use of a stall signal within the block. In this example, the fifo is used to collect the pipeline data as it is output from the pipeline. The former solution may be more difficult and time consuming to implement for larger pipelined blocks. The latter may require larger buffers that may be capable of holding the entire set of data that may potentially exist within the block.

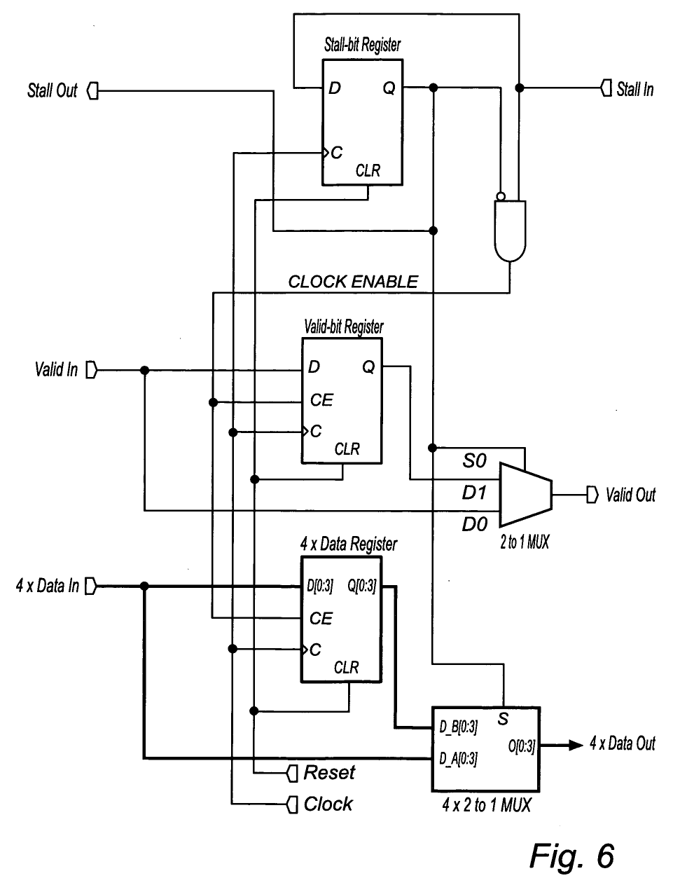

An improved way to combat this limited signal propagation speed may be by using a “stall cutter” according to an example embodiment of the present invention, as illustrated in FIG. 6. A stall cutter may be a register which receives the stall line from a subsequent node and delays it for one cycle. This may reduce the combinatorial length of the stall signal at that point. When the stall cutter receives a valid stall signal, it may buffer data from the previous node during one processing cycle and at the same time may delay the stall signal by the same, or substantially the same, amount. By delaying the stall signal and buffering the input data, no data may be lost, for example, even when longer stall lines are used.

The stall cutter may simplify the implementation of data loops, for example, pipelined data loops. In this example, variations of the protocol for controlling the flow of data may call for the stall signal to take the same path as the data through the loop, for example, in reverse. This may create a combinatorial loop for the stall signal. By placing a stall cutter within the loop, such a combinatorial loop may be avoided, enabling many protocols that would otherwise be harder or to implement.

A stall cutter may be transparent from the point of view of data propagation in the data flow machine. This may allow stall cutters to be added where needed in an automated fashion.

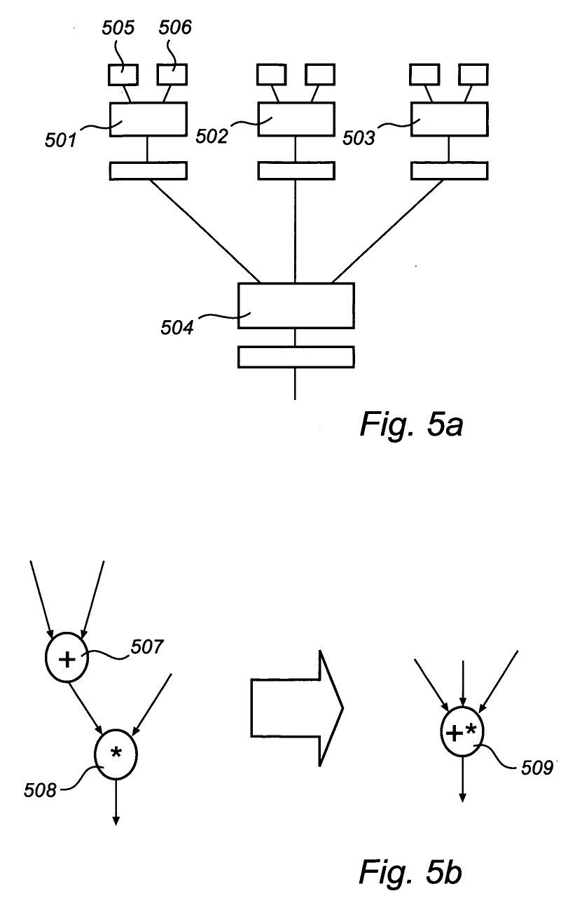

FIG. 5a illustrates another example embodiment of the present invention, wherein the data paths in the graph have been equalized using node merging. For designs which utilize global clock signals, the highest possible clock frequency may be determined by the slowest processing unit. Thus, every processing unit with capability to operate at a higher frequency may be restricted to operate at the frequency set by the slowest unit. For this reason it may be desirable to obtain processing units of equal or nearly equal size, such that no unit will slow down the other units. Even for designs without global clock signals it may be desirable to have two data paths in a forked calculation have equal lengths, for example, the number of nodes present in each data path is the same. By ensuring that the data paths are of equal length, the calculations in the two branches may be performed at the same speed.

As is seen in FIG. 5a, the two nodes 304 and 305 of FIG. 3 have been merged into one node 504. As discussed above this may be done to equalize the lengths of different data paths or for improving and/or optimizing the overall processing speed of the design.

Node merging may be performed by removing the registers between at least a portion of the nodes, wherein the number of nodes will be decreased as the merged nodes become larger. By systematically merging selected nodes, the combinatorial depths of the nodes may become equal, or substantially equal, and the processing speed between different nodes may be equalized.

When nodes are merged, their individual functions may also be merged. This may be done by connecting the different logic elements without any intermediate registers. As the nodes are merged, new firing rules may be determined in order for the nodes to provide data at their outputs when required.

For example, as seen in FIG. 5b, when merging two nodes 507, 508, a new node 509 may be created that has the same number of input and output arcs that the original node had, minus the arcs that connected the two nodes 507, 508 that are combined. As mentioned above, for basic function nodes, like add, multiply, etc. the firing rule may fire when there is data on all inputs, and all outputs may be free to receive data (e.g., a firing rule called nm-firing rule below). Merging two such nodes 507, 508 may result in a new node 509 with three inputs and a single output. Two inputs from add, two inputs from multiply, and one input that may be used in the connection between the two nodes may give three inputs for the merged node. One output from add, one output from multiply and a one output used to connect the two nodes may give a single output from the merged node. The firing rule for the merged node may require data at all three inputs to fire. For example, any merge of nodes with the nm-firing rule may have an nm-firing rule, though the number of inputs and outputs may have changed. The functions of the original two nodes 507, 508 may be merged by directly connecting the output from the first combinatorial block into the input of the other combinatorial block, according to the arc that previously connected them. The register that previously represented the arc between the nodes may be removed. Thus, the result may be a larger combinatorial block.

For nodes that may require data at their inputs and may provide data at their outputs, for example, nodes that may perform arithmetic functions, firing rules for the merged nodes may be the same as for the original nodes.

As mentioned above, the use of functional programming languages may be essential in order to achieve increased parallelism in a data flow machine. According to example embodiments of the present invention, problems of side-effects may be handled using tokens. By using special tokens called instance tokens it may be possible to control the number of possible accesses to a side-effect as well as the order in which these accesses may occur.

Every node which wants to use a side-effect must, besides the ordinary data inputs, have a dedicated data input for the instance token related to the side-effect in question. Besides the data input for the instance token, it must also have an output for the instance token. The data path for the instance token functions as the other data paths in the data flow machine, for example, the node must have data on all relevant inputs before it may perform its operation.

The firing rule for a node that needs access to the side-effect may be such that it must have data on its instance token input (e.g., the instance token itself). When the access to the side-effect is completed, the node may release the instance token at its output. This output may in turn be connected to an instance token input of a subsequent node which may need access to the same side-effect. An instance token path may be established between all nodes that need access to the specific side-effect. The instance token path may decide the order in which the nodes gain access to the side-effect.

For a specific side-effect (e.g., a memory or an indicator), there may be one or more instance tokens moving along its instance token path. Since all, or substantially all, nodes in the chain may need to have data on its inputs in order to gain access to the side-effect, it may be possible to restrict the number of simultaneous accesses to the side-effect by limiting the number data elements on the instance token data path (e.g., limit the number of instance tokens). If one instance token is allowed to exist on the instance token path at a specific time instant, the side-effect may not be accessed from two or more nodes at the same time. Moreover, the order in which the side-effect is accessed may be unambiguously determined by the instance token path. If it is safe to let more than one node gain access to the side-effect, it may be possible to introduce more than one instance token in the path at the same time. It may also be safe to split the instance token path, duplicating the instance token to both paths of the split.

For example, when accessing memory as a side-effect, it may be safe to split the instance token path if both paths contain reads from the memory. In this example, simultaneous access to the memory may be arbitrarily arbited by the memory controller, but since the order of executions for reads do not influence one another this may be safe. In contrast, if the two paths contained writes, the order in which the two writes were actually performed may be essential, since it may decide what value the memory ultimately holds. In this example, the instance token path may not be safely split.

Placing several instance tokens after each other on a single thread of instance token path may represent access to the memory by different “generations” of a pipelined calculation. It may be safe to insert multiple instance tokens after each other, if, for example, it is known that the two generations are unrelated in that they do not access the same parts of the memory.

It may also be possible to place accesses to several different side-effects (e.g., memories or other input or output units) after each other. This may have the effect of unambiguously determining the order of access to each side-effect for each instance token on the path. For example, read from an input unit may be placed before write to an output unit on an instance token path, If several instance tokens exist on the path at the same time, the overall order for reads and writes may remain undetermined, but for each individual instance token on the path there may be a clear ordering between side-effects.

When designing a digital circuit, different types of data flow machines may be mixed. For example a loop with a data-dependent number of iterations may be made as a section of dynamic data flow machine in an otherwise static data flow machine. This may allow for the iteration to be executed in parallel. Such a local dynamic portion of a static data flow machine may operate without the full tag-matching system of the dynamic data flow machine. Instead only tokens need exit the dynamic portion in the same order as they entered it. Since the rest of the machine is static and does not re-order tokens, this may make tokens match.

It may be possible to rearrange the tokens in correct order after the recursion is finished by tagging each token that enters the recursion with a serial number, and using a buffer for collecting tokens that are finishing the recursion out of order. For example, a buffer may be arranged after the recursion step. If a token exits the recursion out of order, it may be placed in the buffer until all tokens with a lower serial number exit the recursion. The size of the buffer may determine how many tokens may exit the recursion out of order, while ensuring that the tokens may be correctly arranged after the completion of the recursion. In some examples, the order of tokens exiting the recursion may be irrelevant, for example, if a simple summation of the values of the tokens that exit the recursion is to be performed. In these examples, both the tagging of the data tokens with a serial number and the buffer may be omitted.

Apart from the data-dependent loop, the use of a local tag-matching and re-ordering scheme may also be used for other types of re-ordering nodes or sub-graphs.

Example embodiments of the present invention may be implemented, in software, for example, as any suitable computer program. For example, a program in accordance with one or more example embodiments of the present invention may be a computer program product causing a computer to execute one or more of the example methods described herein: a method for generating a data flow machine, creating an apparatus for generating a data flow machine through the running of such a computer program on a processor, and/or any combinations of any example embodiments of the present invention.

The computer program product may include a computer-readable medium having computer program logic or code portions embodied thereon for enabling a processor of the apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal (e.g., wireless or terrestrial) embodied in a carrier wave. The computer data signal embodying one or more instructions or functions of an example methodology may be carried on a carrier wave for transmission and/or reception by an entity that executes the instructions or functions of the example methodology. For example, the functions or instructions of the example embodiments may be implemented by processing one or more code segments of the carrier wave, for example, in a computer, where instructions or functions may be executed for generating a data flow machine, creating an apparatus for generating a data flow machine through the running of such a computer program on a processor, and/or any combinations of any example embodiments of the present invention.

Further, such programs, when recorded on computer-readable storage media, may be readily stored and distributed. The storage medium, as it is read by a computer, may enable generating a data flow machine, creating an apparatus for generating a data flow machine through the running of such a computer program on a processor, and/or any combinations of any example embodiments of the present invention.

The example embodiments of the present invention being thus described, it will be obvious that the same may be varied in many ways. For example, the methods according to example embodiments of the present invention, may be implemented in hardware and/or software. The hardware/software implementations may include a combination of processor(s) and article(s) of manufacture. The article(s) of manufacture may further include storage media and/or executable computer program(s).

The executable computer program(s) may include the instructions to perform the described operations or functions. The computer executable program(s) may also be provided as part of externally supplied propagated signal(s). Such variations are not to be regarded as departure from the spirit and scope of the example embodiments of the present invention, and all such modifications as would be obvious to one skilled in the art are intended to be included within the scope of the following claims.

Example embodiments of the present invention being thus described, it will be obvious that the same may be varied in many ways. Such variations are not to be regarded as a departure from the invention, and all such modifications are intended to be included within the scope of the invention.

What is claimed is:

1. A method for implementing digital logic circuitry forming a data flow machine from a graph representation including functional nodes with at least one input or at least one output, and connections indicating connections between the functional nodes, the method comprising:
configuring a first set of hardware elements to perform functions associated with functional nodes of the graph, each hardware element in the first set of hardware elements configured to perform only a function of a corresponding functional node;
configuring a second set of hardware elements enabling data transfer between the hardware elements of said first set of hardware elements according to the connections between the functional nodes; and
configuring electronic circuitry to perform a firing rule for at least one hardware element of said first set of hardware elements.

2. The method according to claim 1, wherein the graph representation is a directed graph.

3. The method according to claim 1, wherein the graph representation is generated from high-level source code specifications.

4. The method according to claim 1, further including,
specifying memory elements independently accessed in parallel for at least one connection between the functional nodes.

5. The method according to claim 1, further including,
specifying at least one of registers, at least one flip/flop and at least one latch for at least one connection between the functional nodes

6. The method according to claim 1, further including,
specifying combinatorial logic for at least one functional node.

7. The method according to claim 1, further including
specifying at least one state machine for at least one functional node.

8. The method according to claim 1, further including,
specifying at least one pipelined device for at least one functional node.

9. An apparatus for implementing digital logic circuitry from a graph representation comprising functional nodes with at least one input or at least one output, and connections indicating the interconnections between the functional nodes, the apparatus being adapted to,
configure a first set of hardware elements to perform functions associated with functional nodes of the graph, each hardware element in the first set of hardware elements to perform a function of a corresponding functional node,
configure a second set of hardware elements, according to connections between the functional nodes, and enabling data transfer between the hardware elements of the first set of hardware elements, and
configure electronic circuitry to perform a firing rule for at least one hardware element of the first set of hardware elements.

10. The apparatus according to claim 9, wherein the graph representation is a directed graph.

11. The apparatus according to claim 9, wherein the graph representation is generated from high-level source code specifications.

12. The apparatus according to claim 9, the apparatus being further adapted to specify memory elements accessible in parallel for at least one connection between the functional nodes.

13. The apparatus according to claim 9, the apparatus further adapted to specify at least one of digital registers, at least one flip/flop and at least one latch for at least one connection between the functional nodes.

14. The apparatus according to claims 9, the apparatus being further adapted to specify combinatorial logic for at least one functional node.

15. The apparatus according to claims 9, the apparatus being further adapted to specify at least one state machine for at least one functional node.

16. The apparatus according to claim 9, the apparatus being further adapted to specify at least one pipelined device for at least one functional node.

17. A data flow machine comprising
a first set of hardware elements adapted to perform data transformation;
a second set of hardware elements interconnecting the first set of hardware elements;
electronic circuitry establishing at least one firing rule for each of the first set of hardware elements; wherein
each hardware element of the first set of hardware elements performs one specific data transformation.

18. The data flow machine according to claim 17, wherein at least one element of the second set of hardware elements is in the form of memory elements accessible in parallel.

19. The data flow machine according to claim 17, wherein at least one element of the second set of hardware elements is in the form of at least one of a register, a flip/flop or a latch.

20. The data flow machine according to claim 17, wherein at least one element in the first set of hardware elements is in the form of combinatorial logic.

21. The data flow machine according to claim 17, wherein at least one element in the first set of hardware elements is in the form of at least one state machine.

22. The data flow machine according to claim 17, wherein at least one element in the first set of hardware elements is in the form of a pipelined device.

23. The data flow machine according to claim 17, wherein the data flow machine is implemented by an ASIC, FPGA, CPLD.

24. A computer program product loadable into the memory of an electronic device having digital computer capabilities, and including software code portions for performing the method of claim 1 when the product is run by the electronic device.

25. A computer program product as defined in claim 24, embodied on a computer-readable medium.
